(19) United States
(12) Patent Application Publication
(10) Pub. No.: US 2003/0065804 A1
(43) Pub. Date: Apr. 3, 2003

(54) Real Time transport protocol connector

(76) Inventors: Marc Owerfeldt, Sunnyvale, CA (US); Ivan Wong, San Jose, CA (US); Michael Bundschuh, Menlo Park, CA (US)

Correspondence Address: MARTINE & PENILLA, LLP, 710 LAKEWAY DRIVE, SUITE 170, SUNNYVALE, CA, 94085, US

(21) Appl. No.: 09/970,724

(22) Filed: Oct. 3, 2001

(51) Int. Cl. G06F 15/16; G06F 15/173

(52) U.S. Cl. 709/231; 709/238

(57) ABSTRACT

An invention is provided for a transport-independent RTP stack. The transport-independent RTP stack includes a transport-independent tasks module, which includes methods that are independent of an underlying transport layer. In communication with the transport-independent module is a connector module, which includes methods that are dependent on the underlying transport layer. In one aspect, the connector module includes data input and output methods, which can be utilized by the transport-independent tasks module to communicate with the underlying transport layer.

### BACKGROUND OF THE INVENTION

1. Field of the Invention

The present invention relates generally to real-time multimedia streaming, and more particularly to a transport-independent real-time protocol stack.

2. Description of the Related Art

With the explosive growth of the Internet, there is a growing interest in using the Internet and other Internet protocol-based networks to deliver multimedia selections, such as audio and video material. Scalable, open-architecture multimedia systems are being used to store and retrieve multimedia data over the Internet. Interactive television, movies on demand, and other multimedia technologies are among the more promising applications for use on these systems.

The Internet is a wide area network offering best effort delivery service. Packets of data are routed as datagrams that carry the address of the intended recipient. A specific connection between the sender and the recipient is not required because all the host nodes on the network include the inherent capability to route datagrams from node to node until delivery is effected. This datagram packet delivery scheme is constructed as a best effort delivery system in which the delivery of datagram packets is not guaranteed.

In many cases, multimedia data requires real-time delivery. In the case of audio or video data, the data stream representing a particular media selection needs to be delivered in the proper sequence and within an abbreviated time period, to allow the user to play back the audio or video selection as it is being sent. The Real-Time Transport Protocol (RTP) is a current de facto standard for delivering real-time content over the Internet or other networks. In the case of an Internet Protocol (IP) based network such as the Internet, RTP utilizes the User Datagram Protocol (UDP) over IP for transport. The term RTP generally refers to two complementary protocols, RTP and Real-Time Control Protocol (RTCP), both defined in RFC 1889: “A Transport Protocol for Real-Time Applications,” which is incorporated herein by reference. The RTP specifies how to carry data that has real-time properties, while the RTCP monitors the quality of service (QoS) and conveys information concerning the participants in an on-going session.

While RTP provides a framework for delivering multimedia streaming data over computer networks, conventional RTP implementations are transport specific. FIG. 1 is a block diagram showing a conventional RTP based multimedia system 100. The multimedia system 100 includes a multimedia application 102 having a transport specific RTP stack 104, which facilitates streaming via a network 106, such as the Internet. Conventional RTP stacks 104 are designed and implemented for a specific network, for example, an Internet Protocol (IP) based network such as the Internet 106. These implementations intermix transport-dependent tasks, such as IP address management, with transport-independent elements, such as packet decoders and encoders.

Unfortunately, this leads to extremely complex systems that cannot easily be ported or adapted to other transport mechanisms, for example Asynchronous Transfer Mode (ATM) based networks. In addition, the inherent complexity of these transport specific RTP stacks 104 makes them error prone and difficult to maintain and extend.

In view of the foregoing, there is a need for an RTP stack that is transport-independent. In addition, the RTP stack should be easily adapted to operate with fundamentally different types of transport layers.

### SUMMARY OF THE INVENTION

Broadly speaking, the present invention fills these needs by providing a transport-independent real-time protocol stack. The present invention provides an RTP connector that separates transport-independent tasks from transport-dependent tasks, thus allowing the real-time protocol stack to be easily adapted to operate with different transport layers. In one embodiment, a transport-independent RTP stack is disclosed. The transport-independent RTP stack includes a transport-independent tasks module, which includes methods that are independent of an underlying transport layer. In communication with the transport-independent module is a connector module, which includes methods that are dependent on the underlying transport layer.

In another embodiment, an RTP connector module is disclosed. The RTP connector module includes an RTP output stream method that returns an RTP output stream to a calling method, and an RTP input stream method that returns an RTP input stream to a calling method. In addition, the RTP connector module includes an RTCP output stream method that returns an RTCP output stream to a calling method, and an RTCP input stream method that returns an RTCP input stream to a calling method.

A further transport-independent RTP stack is disclosed in another embodiment of the present invention. The transport-independent RTP stack includes a transport-independent tasks module having an RTP transmitter module and an RTP receiver module that are each independent of a first underlying transport layer. In addition, the transport-independent RTP stack includes a connector module. The connector module has an RTP output stream method, which is in communication with the RTP transmitter module, and an RTP input stream method, which is in communication with the RTP receiver module. The RTP output stream method and the RTP input stream provide access to the first underlying transport layer. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram showing a conventional RTP based multimedia system;

FIG. 2 is a diagram showing multimedia system, in accordance with an embodiment of the present invention;

FIG. 3 is a block diagram showing an RTP packet for use in a UDP/IP stack;

FIG. 4 is a block diagram showing an RTP based multimedia system, in accordance with an embodiment of the present invention;

FIG. 5 is a block diagram showing a transport-independent RTP stack, in accordance with an embodiment of the present invention;

FIG. 6A is a block diagram showing an RTP connector, in accordance with an embodiment of the present invention;

FIG. 6B is a block diagram showing an RTP connector having additional functionality, in accordance with another embodiment of the present invention;

FIG. 7 is a block diagram illustrating internal methods of a transport-independent RTP stack, in accordance with an embodiment of the present invention; and

FIG. 8 is a block diagram of an exemplary computer system for carrying out the processing according to the invention.

### DETAILED DESCRIPTION OF THE PREFERRED EMBODIMENTS

An invention is disclosed for a transport-independent real-time protocol stack. The present invention provides an RTP connector that separates transport-independent tasks from transport-dependent tasks. In addition, the RTP connector of the embodiments of the present invention allows the RTP stack to be easily adapted to any type of transport layer. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

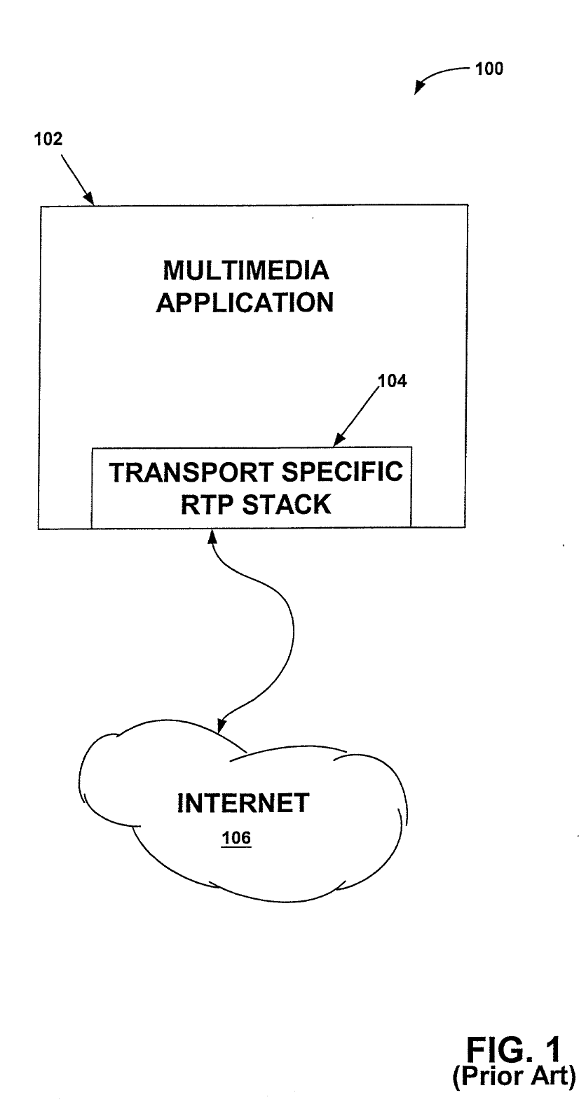

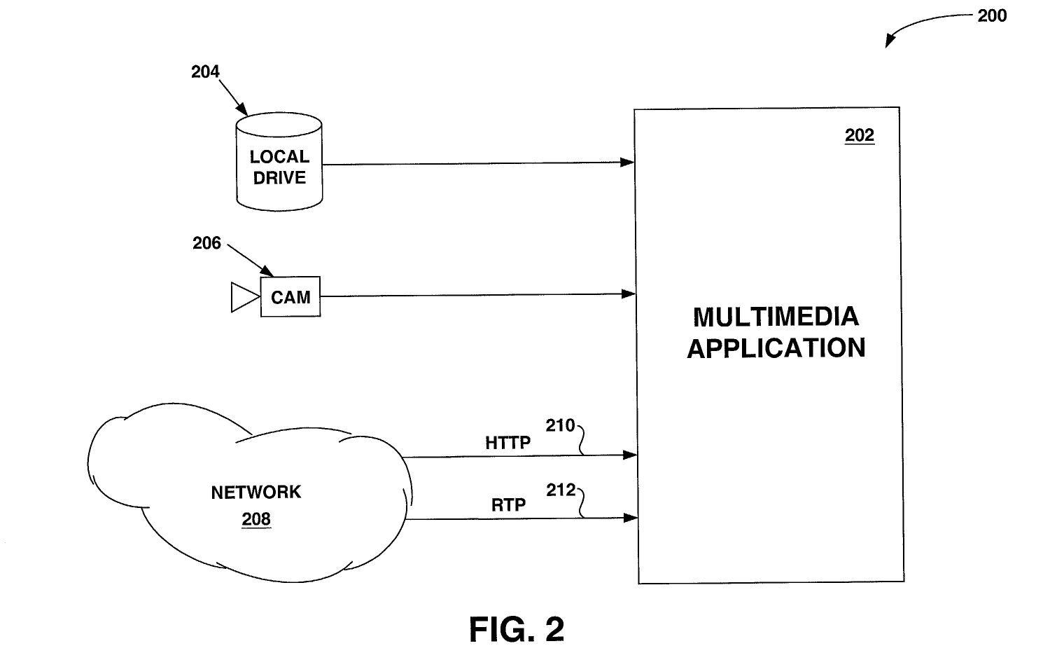

FIG. 1 was described in terms of the prior art. FIG. 2 is a diagram showing multimedia system 200, in accordance with an embodiment of the present invention. The multimedia system 200 includes a multimedia application 202 and illustrates a plurality of sources from which the multimedia application 202 can receive data. These sources include a local drive 204, a video camera 206, and a network 208, such as the Internet. When the source is a network 208, the transport protocol can vary, for example, the data can be received using HTTP 210 or RTP 212.

When the data source is in direct communication with the multimedia application, such as in the case of the local drive 204 or the video camera 206, it is a relatively simple matter to receive, decode, and process the data. However, when multimedia data is received via a network 208, the mechanics of receiving and processing the data packets is more complex. Although HTTP is a generally accepted protocol for use in transmitting non-real-time data such as web pages, HTTP 210 generally does not perform well when used for real-time data transmission. In these situations, RTP 212 generally is used for receiving multimedia data packets.

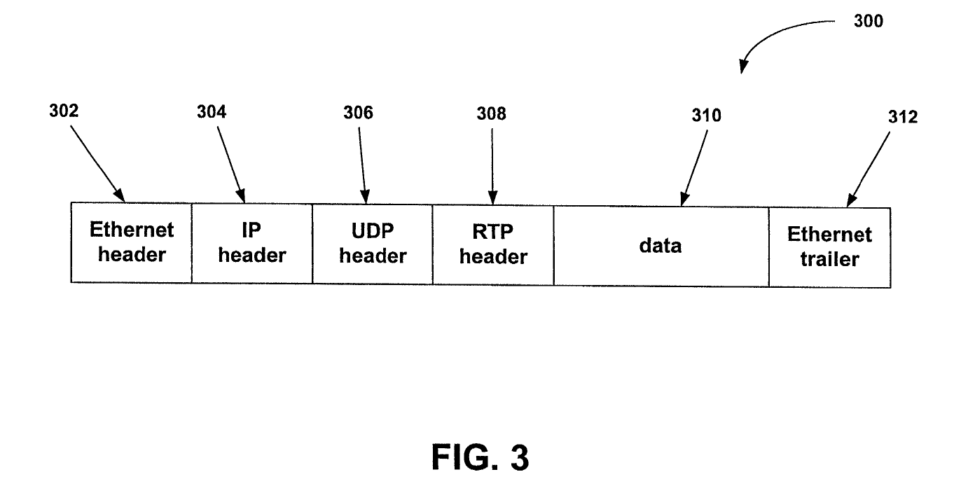

RTP is a protocol that supports real-time transmission of voice and video. FIG. 3 is a block diagram showing an RTP packet 300 for use in a UDP/IP stack. The RTP packet 300 includes an Ethernet header 302, an IP header 304, a User Datagram Protocol (UDP) header 306, an RTP header 308, data 310, and an Ethernet trailer 312. Although FIG. 3 illustrates an RTP packet 300 that operates using a UDP/IP stack, it should be noted that the embodiments of the present invention can be used with any type of stack. It should also be noted that the RTP packet 300 can be used with any type of layer 2 protocol. For exemplary purposes the RTP packet 300 is shown for use with the Ethernet protocol. When used in a UDP/IP stack, the RTP packet 308 generally is created first and then the packet is moved down the stack to UDP and IP.

The RTP packet 300 rides on top of UDP and includes timestamping and synchronization information in the RTP header 308 for proper reassembly at the receiving end. RTCP is a companion protocol that is used to maintain Quality of Service (QoS). RTP transmitters, receivers, mixers and translators periodically send each other RTCP packets that include information such as timestamp correlations used to synchronize streams, interarrival jitter, and transmission delays, which allow analysis of the condition of the network and the quality of server, for example, by computing round-trip times.

As mentioned above, conventional RTP stacks are transport-specific, leading to difficulties when the application needs to be ported into another environment. The embodiments of the present invention address this issue by providing a transport-independent RTP stack.

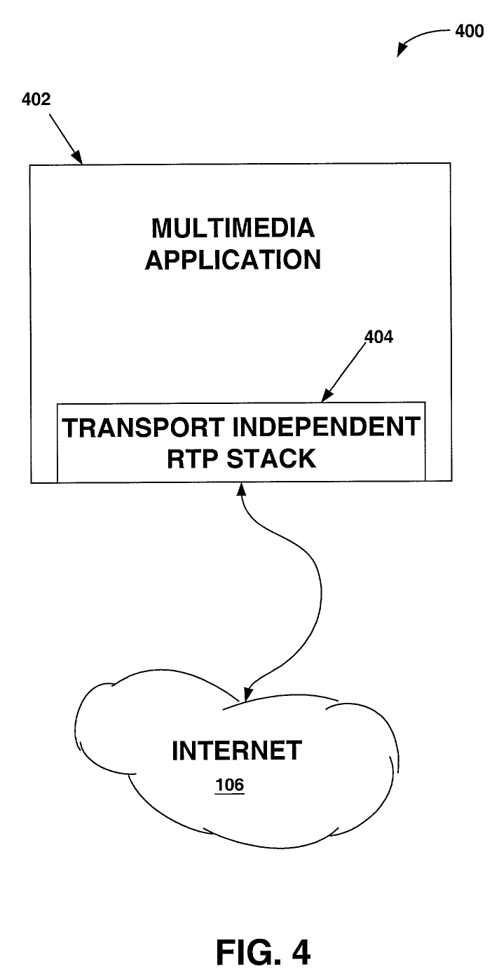

FIG. 4 is a block diagram showing an RTP based multimedia system 400, in accordance with an embodiment of the present invention. The multimedia system 400 includes a multimedia application 402 having a transport-independent RTP stack 404, which facilitates streaming via the network 106, such as the Internet. As mentioned above, conventional RTP stacks are designed and implemented for a specific network, for example, an IP-based network such as the Internet. These implementations intermix transport-dependent tasks, such as IP address management, with transport-independent elements, such as packet decoders and encoders.

However, the embodiments of the present invention provide a transport-independent RTP stack 404, which can be easily adapted to any type of transport layer, such as ATM or IP transport layers. In particular, the transport-independent RTP stack 404 of the embodiments of the present invention separates truly transport-independent tasks from the transport-dependent tasks. As will be discussed in greater detail subsequently, the embodiments of the present invention also provide an RTP connector that can be used to adapt the transport-independent RTP stack 404 to any type of transport layer.

In this manner, the multimedia application 402 can be written in generic terms to source and sink streaming data over the network 106 via the transport-independent RTP stack 404. Thereafter, the multimedia application 402 can be adapted to operate over another network environment by adapting the RTP connector of the transport-independent RTP stack 404 to the new network transport layer. Thus, the embodiments of the present invention allow the RTP stack 404, and by extension the utilizing application 402, to be easily ported to any type of transport layer without extensive rewriting of the application code.

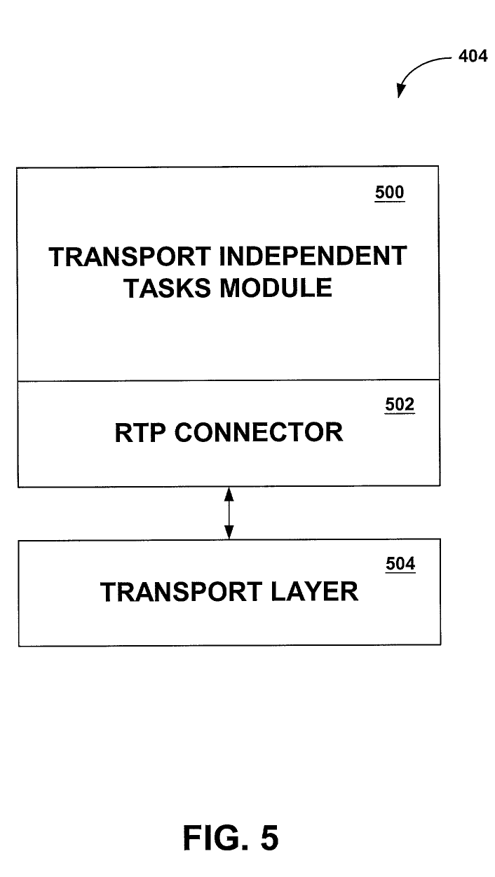

FIG. 5 is a block diagram showing a transport-independent RTP stack 404, in accordance with an embodiment of the present invention. The transport-independent RTP stack 404 includes a transport-independent tasks module 500 and an RTP connector 502, which facilitates communication with the transport layer 504. The transport-independent tasks module 500 includes the truly transport-independent tasks utilized during RTP streaming. For example, these transport-independent tasks can include packetization, depacketization, session management, and other transport-independent tasks as will be apparent to those skilled in the art.

The RTP connector 502 includes the transport-dependent tasks utilized during RTP streaming via the transport layer 504. These transport-dependent tasks can include transmission tasks, data receiving tasks, and other transport-dependent tasks as will be apparent to those skilled in the art. As mentioned above, the RTP connector 502 can be used to adapt the transport-independent RTP stack 404 to any type of transport layer.

In particular, the RTP connector 502 can be implemented to operate with any type of transport 504, then registered using an initialization call. Although the following discussion describes the present invention in terms of the Java programming language, it should be noted that any programming language can be used to implement the embodiments of the present invention. For example, when implementing the embodiments of the present invention using Java, the Java classes are compiled into machine independent bytecode class files which are executed by a machine-dependent virtual machine. The virtual machine provides a level of abstraction between the machine independence of the bytecode classes and the machine-dependent instruction set of the underlying computer hardware. A class loader is responsible for loading the byte-code class files as needed, and an interpreter or just-in-time compiler provides for the transformation of bytecodes into machine code.

More specifically, Java is a programming language designed to generate applications that can run on all hardware platforms, small, medium and large, without modification. Developed by Sun, Java has been promoted and geared heavily for the Web, both for public Web sites and Intranets. Generally, Java programs can be called from within HTML documents or launched standalone. When a Java program runs from a Web page, it is called a “Java applet,” and when run on a Web server, the application is called a “servlet.”

Java is an interpreted language. The source code of a Java program is compiled into an intermediate language called “bytecode.” The bytecode is then converted (interpreted) into machine code at runtime. Upon finding a Java applet, the Web browser invokes a Java interpreter (Java Virtual Machine), which translates the bytecode into machine code and runs it. Thus, Java programs are not dependent on any specific hardware and will run in any computer with the Java Virtual Machine software. On the server side, Java programs can also be compiled into machine language for faster performance. However a compiled Java program loses hardware independence as a result.

As mentioned above, in addition to Java, other programming languages may be used to implement the embodiments of the present invention, including both procedural and object oriented programming languages. Object-oriented programming is a method of creating computer programs by combining certain fundamental building blocks, and creating relationships among and between the building blocks. The building blocks in object-oriented programming systems are called “objects.” An object is a programming unit that groups together a data structure (instance variables) and the operations (methods) that can use or affect that data. Thus, an object consists of data and one or more operations or procedures that can be performed on that data. The joining of data and operations into a unitary building block is called “encapsulation.”

An object can be instructed to perform one of its methods when it receives a “message.” A message is a command or instruction to the object to execute a certain method. It consists of a method selection (name) and a plurality of arguments that are sent to an object. A message tells the receiving object what operations to perform.

One advantage of object-oriented programming is the way in which methods are invoked. When a message is sent to an object, it is not necessary for the message to instruct the object how to perform a certain method. It is only necessary to request that the object execute the method. This greatly simplifies program development.

Object-oriented programming languages are predominantly based on a “class” scheme. A class defines a type of object that typically includes both instance variables and methods for the class. An object class is used to create a particular instance of an object. An instance of an object class includes the variables and methods defined for the class. Multiple instances of the same class can be created from an object class. Each instance that is created from the object class is said to be of the same type or class.

A hierarchy of classes can be defined such that an object class definition has one or more subclasses. A subclass inherits its parent's (and grandparent's etc.) definition. Each subclass in the hierarchy may add to or modify the behavior specified by its parent class.

Thus, using the Java language, embodiments of the present invention can provide a default RTP connector 502 for use with a particular type of transport, for example, an IP-based network via UDP datagram packets. Then, a new RTP connector 502 can be designed as a class for use over another transport, such as ATM. The new ATM RTP connector class can then be implemented by passing the new ATM RTP connector class to an initialization method.

The transport-independent tasks module 500 acts as a data source and data sink for the application it is servicing. In this manner, the application program using the transport-independent RTP stack 404 can be designed to communicate with the transport-independent tasks module 500 without regard to the specific type of network transport protocol that will be used with the system. Similarly, the transport-independent tasks module 500 communicates with the RTP connector 502 without regard to the specific protocol used for the transport 504. In particular, the transport-independent tasks module 500 sends data to, and receives data from the RTP connector 502 in the same manner, regardless of the specific protocol used for the transport 504.

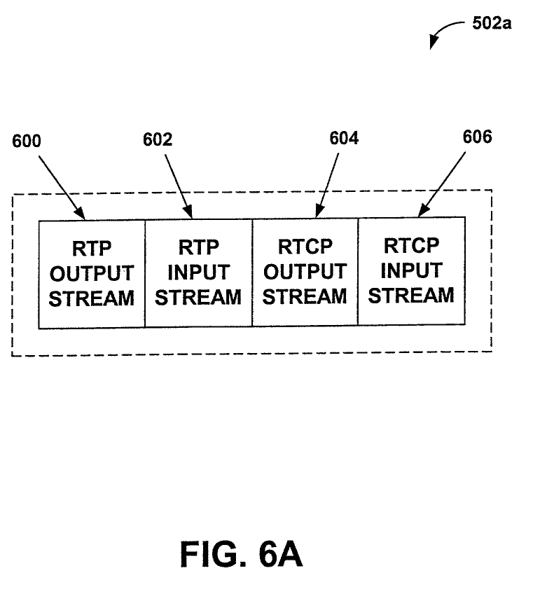

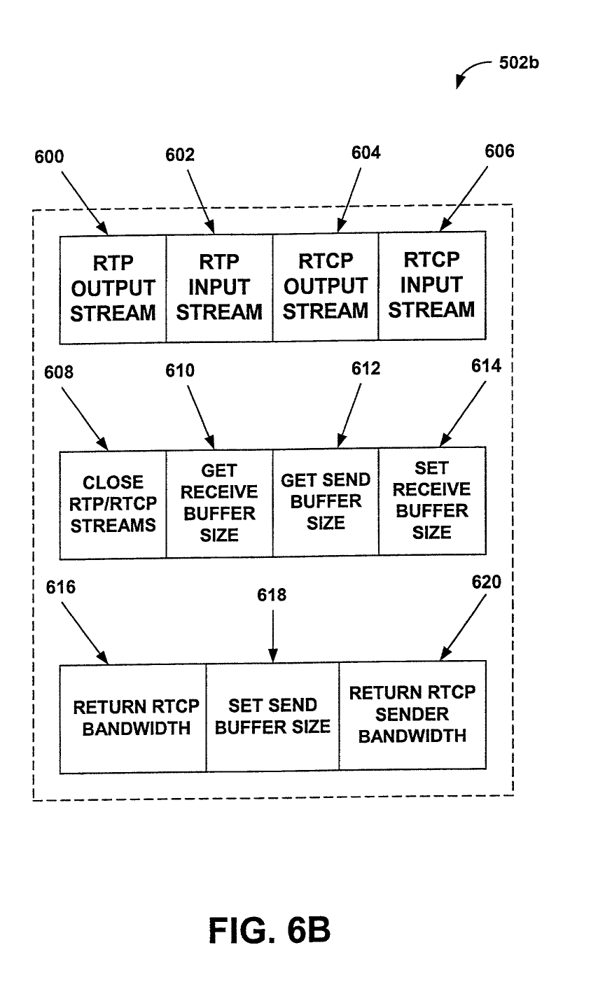

FIG. 6A is a block diagram showing an RTP connector 502a, in accordance with an embodiment of the present invention. The RTP connector 502a includes four fundamental methods for reading from and writing to the transport layers. Specifically, RTP connector 502a includes an RTP output stream method 600, an RTP input stream method 602, an RTCP output stream method 604, and an RTCP input stream method 606.

The RTP output stream method 600 returns an output stream to send RTP data out over the network via the transport layers. To write data, a Java program opens a stream to a data sink and writes to it in a serial fashion. Using the RTP output stream method 600, the transport-independent tasks module 500 can write RTP data to the network regardless of the actual transport being used.

The RTP input stream method 602 returns an input stream to receive RTP data from the network via the transport layers. To bring data into a program, a Java program opens a stream to a data source and reads the information serially. Similar to the RTP output stream method 600, the transport-independent tasks module 500 can read RTP data from the network regardless of the actual transport being used via the RTP input stream method 602.

The RTCP output stream method 604 returns an output stream to send RTCP data out over the network via the transport layers, and the RTCP input stream method 606 returns an input stream to receive RTCP data from the network via the transport layers. As with the RTP streams, the RTCP output stream method 604 and the RTCP input stream method 606 can be used to read and write RTCP control data to and from the network regardless of the actual transport protocol being used.

In addition to the fundamental methods described above, an RTP connector of the embodiments of the present invention can include additional transport-dependent methods that are useful for managing transport input/output. FIG. 6B is a block diagram showing an RTP connector 502b having additional functionality, in accordance with another embodiment of the present invention. The RTP connector 502b includes a plurality of supplementary methods in addition to the RTP and RTCP stream methods discussed above with respect to FIG. 6A.

These supplementary methods include a close all RTP/RTCP streams method 608, a get receive buffer size method 608, a get send buffer size method 612, a set receive buffer size method 614, a return RTCP bandwidth fraction method 616, a set send buffer size method 618, and a return RTCP sender bandwidth fraction method 620. The set receive buffer size method 614 is used by the platform's networking code as a hint for the size to set the underlying network I/O buffers. The get receive buffer size method 608 returns the value that is the buffer size used by the platform for input.

The set send buffer size method 618 specifies the desired buffer size, which provides a hint to the platform's networking code as to the size to set the underlying network I/O buffers. Increasing the buffer size can enhance the performance of the network I/O for high-volume connection, while decreasing the buffer size can help reduce the backlog of incoming data. For UDP, the set send buffer size method 618 sets a maximum size of a packet that can be sent on the socket. Conversely, the get send buffer size method 612 returns the buffer size that is used by the platform for output.

The return RTCP bandwidth fraction method 616 returns the bandwidth portion utilized for RTCP, which is generally about 5 percent of the total bandwidth available. The RTCP bandwidth fraction can also be used to initialize the RTPManager object. The RTP specification recommends ¼ of the RTCP bandwidth to be dedicated to active data senders. The return RTCP sender bandwidth fraction method 620 returns the sender bandwidth portion, and can also be used to initialize the RTPManager object.

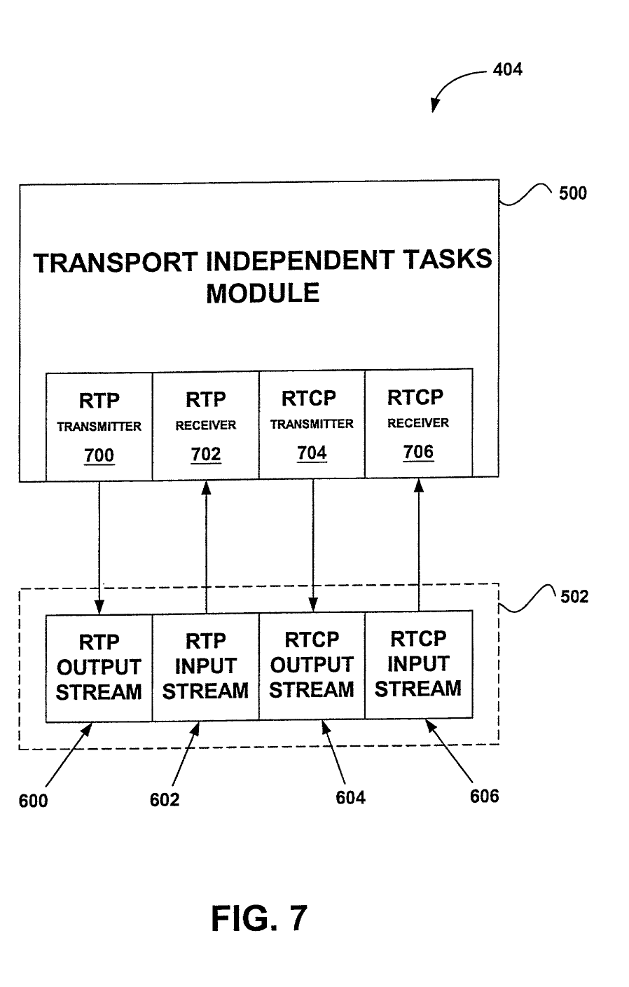

The RTP connector 502a of the embodiments of the present invention reduces the transport-dependent tasks to a small set of methods. Then, the data that is generated by these methods can be processed in general terms, rather than in complex, network-specific terms, as discussed in greater detail next with reference to FIG. 7.

FIG. 7 is a block diagram illustrating internal methods of a transport-independent RTP stack 404, in accordance with an embodiment of the present invention. The transport-independent RTP stack 404 includes a transport-independent tasks module 500 and an RTP connector 502. The transport-independent tasks module 500 includes the truly transport-independent tasks utilized during RTP streaming. For example, these transport-independent tasks can include packetization, depacketization, session management. In addition, the transport-independent tasks module 500 includes a plurality of RTP/RTCP modules, namely, an RTP transmitter module 700, an RTP receiver module 702, an RTCP transmitter module 704, and an RTCP receiver module 706.

The RTP connector 502 includes the transport-dependent tasks utilized during RTP streaming via the transport. As mentioned previously, the transport-dependent tasks include four fundamental methods for reading from and writing to the transport layers. Specifically, RTP connector 502 includes an RTP output stream method 600, an RTP input stream method 602, an RTCP output stream method 604, and an RTCP input stream method 606. As mentioned above, RTP connector can be used to adapt the transport-independent RTP stack 404 to any type of transport layer.

In operation, the RTP transmitter module 700 transmits RTP data to the network regardless of the actual transport being used via the RTP output stream method 600. In particular, the RTP output stream method 600 returns an output stream to the RTP transmitter module 700, which can then use the output stream to transmit RTP data to the network in a transport-independent manner, rather than using complex, network-specific operations.

Similarly, the RTP receiver module 702 receives RTP data from the network regardless of the actual transport being used via the RTP input stream method 602. In particular, the RTP input stream method 602 returns an input stream to the RTP receiver module 702, which can then use the input stream to receive RTP data from the network in a transport-independent manner, rather than using complex, network-specific operations.

As with the RTP modules, the RTCP transmitter module 704 and RTCP receiver module 706 transmit and receive RTP data to and from the network regardless of the actual transport being used via the RTCP output stream method 604 and the RTCP input stream method 606. In particular, the RTCP output stream method 604 and the RTCP input stream method 606 return streams to the RTCP transmitter module 704 and the RTCP receiver module 706. The RTCP transmitter module 704 and the RTCP receiver module 706 can then use the streams to transmit and receive RTCP data to and from the network in a transport-independent manner.

Embodiments of the present invention may employ various computer-implemented operations involving data stored in computer systems to drive computer software, including application programs, operating system programs, peripheral device drivers, etc. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations. An exemplary structure for the invention is described below.

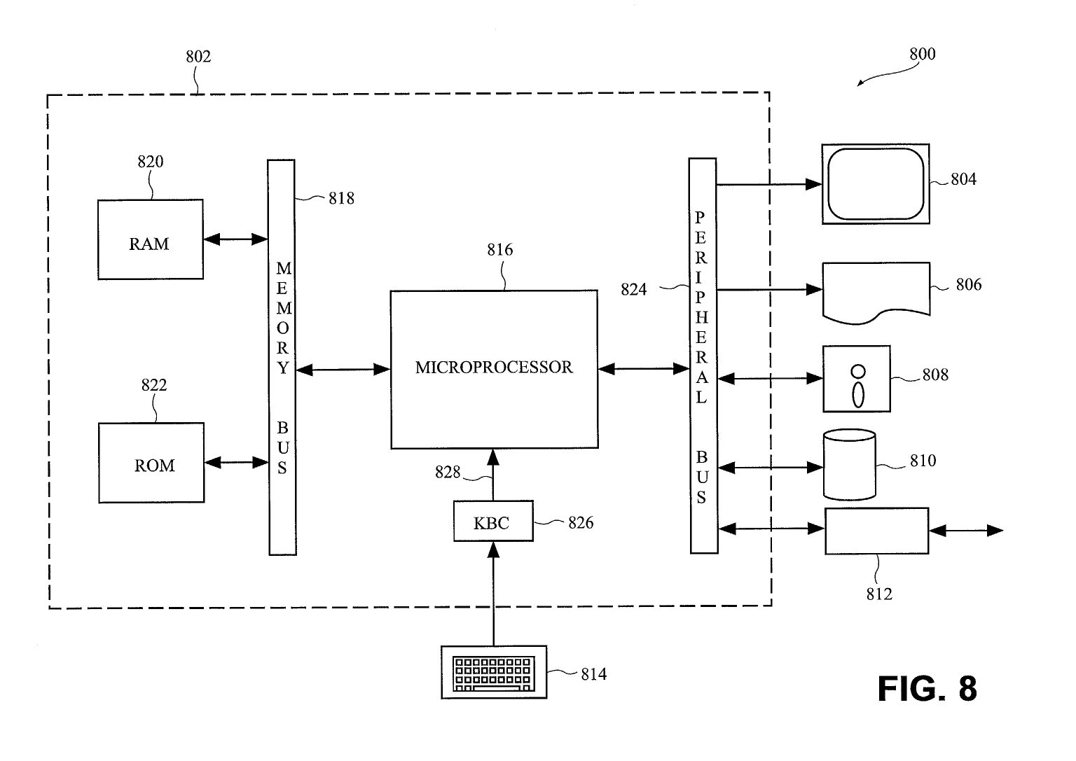

FIG. 8 is a block diagram of an exemplary computer system 800 for carrying out the processing according to the invention. The computer system 800 includes a digital computer 802, a display screen (or monitor) 804, a printer 806, a floppy disk drive 808, a hard disk drive 810, a network interface 812, and a keyboard 814. The digital computer 802 includes a microprocessor 816, a memory bus 818, random access memory (RAM) 820, read only memory (ROM) 822, a peripheral bus 824, and a keyboard controller (KBC) 826. The digital computer 802 can be a personal computer (such as an IBM compatible personal computer, a Macintosh computer or Macintosh compatible computer), a workstation computer (such as a Sun Microsystems or Hewlett-Packard workstation), or some other type of computer.

The microprocessor 816 is a general purpose digital processor, which controls the operation of the computer system 800. The microprocessor 816 can be a single-chip processor or can be implemented with multiple components. Using instructions retrieved from memory, the microprocessor 816 controls the reception and manipulation of input data and the output and display of data on output devices.

The memory bus 818 is used by the microprocessor 816 to access the RAM 820 and the ROM 822. The RAM 820 is used by the microprocessor 816 as a general storage area and as scratch-pad memory, and can also be used to store input data and processed data. The ROM 822 can be used to store instructions or program code followed by the microprocessor 816 as well as other data.

The peripheral bus 824 is used to access the input, output, and storage devices used by the digital computer 802. In the described embodiment, these devices include the display screen 804, the printer device 806, the floppy disk drive 808, the hard disk drive 810, and the network interface 812. The keyboard controller 826 is used to receive input from keyboard 814 and send decoded symbols for each pressed key to microprocessor 816 over bus 828.

The display screen 804 is an output device that displays images of data provided by the microprocessor 816 via the peripheral bus 824 or provided by other components in the computer system 800. The printer device 806, when operating as a printer, provides an image on a sheet of paper or a similar surface. Other output devices such as a plotter, typesetter, etc. can be used in place of, or in addition to, the printer device 806.

The floppy disk drive 808 and the hard disk drive 810 can be used to store various types of data. The floppy disk drive 808 facilitates transporting such data to other computer systems, and hard disk drive 810 permits fast access to large amounts of stored data.

The microprocessor 816, together with an operating system, operates to execute computer code and produce and use data. The computer code and data may reside on the RAM 820, the ROM 822, or the hard disk drive 810. The computer code and data could also reside on a removable program medium and loaded or installed onto the computer system 800 when needed. Removable program media include, for example, CD-ROM, PC-CARD, floppy disk and magnetic tape.

The network interface 812 is used to send and receive data over a network connected to other computer systems. An interface card or similar device and appropriate software implemented by the microprocessor 816 can be used to connect the computer system 800 to an existing network and transfer data according to standard protocols.

The keyboard 814 is used by a user to input commands and other instructions to the computer system 800. Other types of user input devices can also be used in conjunction with the present invention. For example, pointing devices such as a computer mouse, a track ball, a stylus, or a tablet can be used to manipulate a pointer on a screen of a general-purpose computer.

The invention can also be embodied as computer readable code on a computer readable medium. The computer readable medium is any data storage device that can store data, which can be thereafter, be read by a computer system. Examples of the computer readable medium include read-only memory (ROM), random-access memory (RAM), CD-ROMs, magnetic tape, and optical data storage devices. The computer readable medium can also be distributed over a network that couples computer systems so that the computer readable code is stored and executed in a distributed fashion.

Furthermore, the same or similar methods and apparatuses described above for programming a hardware device can also be used for performing other particular maintenance operations on the hardware device. For example, operations such as erasing a ROM, reading a ROM, or performing a checksum on a ROM can be performed.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A transport-independent real-time transport protocol (RTP) stack, comprising:
a transport-independent tasks module, wherein the transport-independent tasks module includes methods that are independent of an underlying transport layer; and
a connector module in communication with the transport-independent module, wherein the connector module includes methods that are dependent on the underlying transport layer.

2. A transport-independent RTP stack as recited in claim 1, wherein the connector module includes data input and output methods.

3. A transport-independent RTP stack as recited in claim 2, wherein the data input and output methods are utilized by the transport-independent tasks module to communicate with the underlying transport layer.

4. A transport-independent RTP stack as recited in claim 3, wherein the data input and output methods include an RTP output stream method that returns an RTP output stream to a calling method.

5. A transport-independent RTP stack as recited in claim 4, wherein the data input and output methods include an RTP input stream method that returns an RTP input stream to a calling method.

6. A transport-independent RTP stack as recited in claim 3, wherein the data input and output methods include a real-time transport control protocol (RTCP) output stream method that returns an RTCP output stream to a calling method.

7. A transport-independent RTP stack as recited in claim 6, wherein the data input and output methods include an RTCP input stream method that returns an RTCP input stream to a calling method.

8. A real-time transport protocol (RTP) connector module, comprising:
an RTP output stream method that returns an RTP output stream to a calling method;
an RTP input stream method that returns an RTP input stream to a calling method;
a real-time transport control protocol (RTCP) output stream method that returns an RTCP output stream to a calling method; and
an RTCP input stream method that returns an RTCP input stream to a calling method.

9. AN RTP connector module as recited in claim 8, wherein the RTP connector module generates transport-independent input/output streams.

10. AN RTP connector module as recited in claim 9, wherein the transport input/output streams provide access to a particular type of underlying transport layer.

11. AN RTP connector module as recited in claim 10, wherein the RTP connector module is in communication with a transport-independent tasks module, wherein the transport-independent tasks module includes methods that are independent of the underlying transport layer.

12. AN RTP connector module as recited in claim 11, wherein the transport-independent tasks module processes the transport-independent input/output streams using transport-independent operations.

13. A transport-independent real-time transport protocol (RTP) stack, comprising:
a transport-independent tasks module having an RTP transmitter module and an RTP receiver module, wherein the RTP transmitter module and the RTP receiver module are independent of a first underlying transport layer; and
a connector module having an RTP output stream method in communication with the RTP transmitter module, and an RTP input stream method in communication with the RTP receiver module, wherein the RTP output stream method and the RTP input stream provide access to the first underlying transport layer.

14. A transport-independent RTP stack as recited in claim 13, wherein the RTP output stream method returns an RTP output stream to the RTP transmitter module.

15. A transport-independent RTP stack as recited in claim 14, wherein the RTP input stream method returns an RTP input stream to the RTP receiver module.

16. A transport-independent RTP stack as recited in claim 13, wherein the transport-independent tasks module further includes a real-time transport control protocol (RTCP) transmitter module and an RTCP receiver module.

17. A transport-independent RTP stack as recited in claim 16, wherein the RTCP transmitter module and the RTCP receiver module are independent of the first underlying transport layer.

18. A transport-independent RTP stack as recited in claim 17, wherein the connector module further includes an RTCP output stream method that returns an RTCP output stream to the RTCP transmitter module.

19. A transport-independent RTP stack as recited in claim 18, wherein the connector module further includes an RTCP input stream method that returns an RTCP input stream to the RTCP receiver module.

20. A transport-independent RTP stack as recited in claim 18, wherein the connector module c an be modified to operate utilizing a second underlying transport without modifying the transport-independent tasks module.
